(19) United States
(12) Patent Application Publication
(10) Pub. No.: US 2012/0170269 A1
(43) Pub. Date: Jul. 5, 2012

(54) BEAM COLLECTION COMBINING LED ILLUMINATION LIGHT SOURCE

(76) Inventors: Baoyu Jin, Zhuhai (CN); Gang Yang, Zhuhai (CN); Xueyu Rong, Zhuhai (CN)

(21) Appl. No.: 13/393,778

(22) PCT Filed: Sep. 8, 2010
(86) PCT No.: PCT/CN2010/076722

§ 371 Date: Mar. 1, 2012

(30) Foreign Application Priority Data
Sep. 9, 2009 (CN) 200920194767.7

(51) Int. Cl. F21V 7/00

(52) U.S. Cl. 362/247

(57) ABSTRACT

A beam collection combining LED illumination light source includes a substrate. One or more LED chips (30) are provided on the substrate. Upon each LED chip, a corresponding reflective cup (40) is provided. Each LED chip is located at the bottom of the reflective cup. The reflective cup is a revolving body. The inner wall of the reflective cup is a curved surface bended inwards. The curved surface is a primary optical curved surface.

### FIELD OF THE INVENTION

The invention relates to a light source, in particular to a beam collection combining LED illumination light source. The invention is based on the Chinese utility model application No. 200920194767.7 filed on Sep. 9, 2009 and the content of the application is cited in the text as a reference document closely related to the invention.

### BACKGROUND OF THE INVENTION

LED light source is used as a novel light source, which has the advantages of energy saving, environmental protection, long life-spa, low energy consumption and so on, and it has been widely applied in the fields of household lighting, commercial lighting, road lighting, industrial and mineral lighting, etc.

When the LED light source is applied to the street lamps, the glare phenomenon tends to occur as the LED light source produces high-brightness light, thus resulting in potential traffic safety hazard. The glare phenomenon refers to visual conditions which result in uncomfortable visual perception or reduce the visibility of objects due to improper brightness distribution in visual field or the existence of extreme contrast in space or time. As the traditional LED light sources are rarely provided with highly efficient and reasonable glare-proof devices, the high-brightness light emitted by the LED light sources tends to affect users.

Therefore, the Chinese invention patent Publication No. CN101220928A discloses a glare-proof LED lighting device, which comprises an LED chip and a composite reflector, wherein the LED chip is arranged on the inner wall of the composite reflector shielding separation bars are arranged on the composite reflector simultaneously; and the LED chip is arranged between two adjacent shielding separation bars. The LED lighting device utilizes the composite reflector to reflect light emitted by the LED chip to places required to be illuminated and utilizes the shielding separation bars to shield light emitted to both sides by the LED chip, thus avoiding glare.

However, as illustrated in FIG. 1, light emitted by the LED chip at the position at which the composite reflector 2 and the shielding separation bars 3 are close to each other can be only emitted from the LED lighting device after reflected for four times, thus the light-emitting efficiency of the LED lighting device can be greatly reduced.

On the assumption that the light absorption rate of the inner wall surfaces of the composite reflector 2 and the shielding separation bars 3 is 0.1, the light-emitting efficiency of the LED lighting device after the light is reflected for four times is

(1−0.1)4×100%=65.65% (Formula 1)

Obviously, although the LED lighting device can effectively inhibit glare, the light-emitting efficiency of the LED chip is reduced after the light is reflected for four times, thus resulting in light waste.

### SUMMARY OF THE INVENTION

The main object of the invention is to provide a beam collection combining LED illumination light source capable of effectively inhibiting glare.

Another object of the invention is to provide a beam collection combining LED illumination light source with high light-emitting efficiency.

In order to achieve the objects, the invention provides a beam collection combining LED illumination light source, which comprises a substrate, wherein one or more LED chips are arranged on the substrate; a corresponding reflective cup is arranged on each LED chip, and each LED chip is arranged at the bottom of the reflective cup which is a revolving body; and the inner wall of the reflective cup is a curved surface bended inwards, and the curved surface is a primary optical design curved surface.

It can be seen from the proposal that light emitted by the LED chips to both sides can be effectively controlled, by considering people's habits, as the inner walls of the reflective cups are designed to be curved surfaces bended inwards, and the light will be reflected to the required places, thus effectively avoiding glare and reducing uncomfortable on drivers, pedestrians and other users.

Moreover, the reflective cups are revolving botube chips, which means reflective cups are not provided with transitional included angles for two planes. Thus the light emitted by the LED chips can be emitted from the inner walls of the reflective cups only after reflected for one time. That is to say, the LED light source adopts primary light design and the light emitted by the LED chips is only reflected for one time by the inner walls of the reflective cups, thus the light-emitting efficiency of the LED light source can be improved.

One preferred proposal of the invention is as follows: a connector is arranged on the substrate and provided with through holes; the LED chips are contained inside the through holes; reflective cup holders are designed on the through holes of the connector; and the reflective cups are fixed on the reflective cup holders.

Therefore, as the LED chips are not directly connected with the reflective cups, the impact of the heat generated by the LED chips on the reflective cups can be effectively reduced, namely the phenomenon that the reflective cups are deformed at high temperatures can be avoided. Meanwhile, the connector can also protect a gold thread connected on the substrate by spot welding, thus the damage of the gold thread can be avoided. In addition, as the reflective cups are fixed on the connector, the positions of the LED chips and the reflective cups are fixed relatively, thus the displacement caused by the vibration of the beam collection combining LED illumination light source can be avoided.

The further proposal of the invention is that the substrate is a ceramic-based two-sided copper clad plate. As the ceramic-based two-sided copper clad plate has the thermal expansion coefficient close to that of the LED chips and radiators, the ceramic-based two-sided copper clad plate can well realize heat dissipation. Then the heat generated by the LED chips can be quickly conducted away from the copper clad surfaces by adoption of the ceramic-based two-sided copper clad plate, and the surface temperature of the substrate can be reduced and the LED light source has good thermal performance.

### BRIEF DESCRIPTION OF THE DRAWINGS

FIG. 1 is a partial diagram of LED chips and reflectors in the traditional LED light source;

FIG. 2 is a structure diagram of the embodiment of the invention;

FIG. 3 is a partial exploded enlarged drawing of the embodiment of the invention;

FIG. 4 is a semi-sectional enlarged drawing of LED chips and reflective cups in the embodiment of the invention.

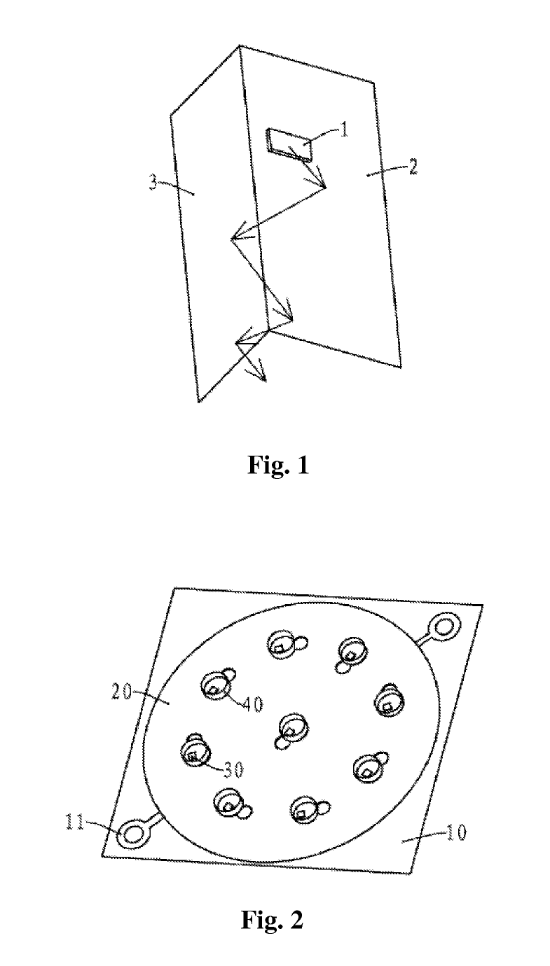

Further description is given to the invention with the attached embodiments and drawings.

### DETAILED DESCRIPTION OF THE PREFERRED EMBODIMENTS

As illustrated in FIG. 2, the beam collection combining LED illumination light source provided by the invention comprises a substrate 10 which is a ceramic-based two-sided copper clad plate. That means the center layer of the substrate 10 is made of ceramic materials and on both sides of the ceramic materials are formed by cladding copper. A copper clad layer on the upper surface of the substrate 10 is subjected to etching to form a metallic conductor 11, and LED chips 30 are welded on the metallic conductor 11.

A copper clad layer is also arranged on the lower surface of the substrate 10. Preferably, the copper clad layer on the lower surface of the substrate 10 is arranged on the lower surface of the whole substrate 10, is connected with a heat sink through a heat-transfer device and used for conducting away the heat generated by the LED chips 30, and provides convenience for the heat dissipation of an LED lighting device.

As illustrated in FIG. 2, nine LED chips 30 are arranged on the substrate 10, eight of which are arranged on a concentric circle and the ninth of which is arranged on the center of the concentric circle. Moreover, the nine LED chips are subjected to one-step encapsulated molding. Of course, in the case of actual application, the shape of the substrate 10, the positions of the LED chips and the like can be set according to actual needs.

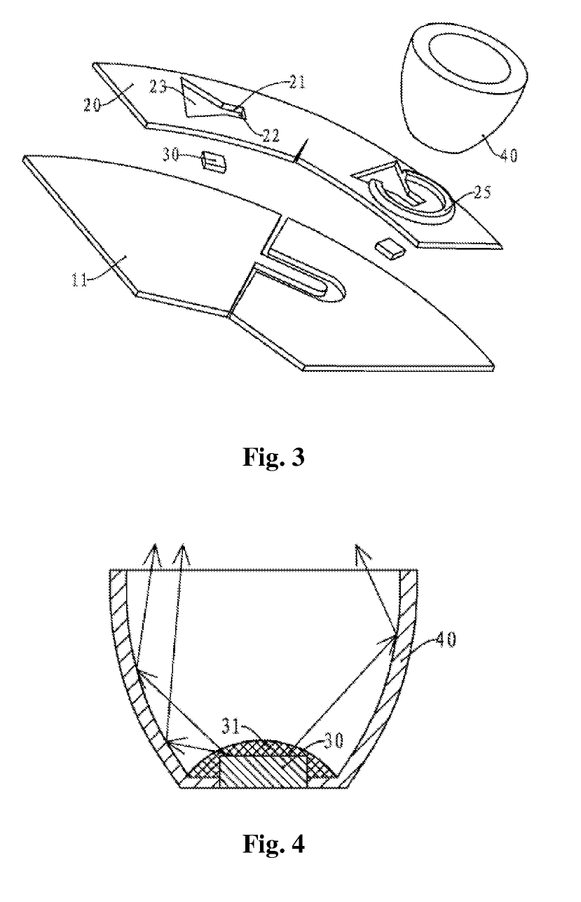

A connector 20 is arranged on the upper surface of the substrate 10, is a circular tabular body, and is provided with a plurality of through holes. As illustrated in FIG. 3, a through hole 21 is reserved on the connector 20 at the position of each LED chip 30 and provided with a roughly square first portion 22 and a roughly trapeziform second portion 23, wherein the LED chip 30 can pass through the first portion 22 of the through hole 21, and the upper end face of the LED chip 30 is higher than the upper surface of the connector 20.

Nine reflective cups 40 are arranged on the connector 20; each reflective cup 40 is arranged on each LED chip and is a hollow revolving body, and the inner wall of the reflective cup 40 is a curved surface bended inwards, and the curved surface is preferably a conicoid, and more specifically a conic revolving surface designed after calculation. The revolving surface is designed according to the reflection law. For example, a conic is one part of an ellipse or a parabola and the like, and the inner wall of the reflective cup 40 is a primary optical design curved surface.

The top of the reflective cup 40 is open and the bottom of the reflective cup 40 is provided with a through hole, namely a cavity body of which both ends are open is formed in the reflective cup 40. The LED chip 30 passes through the through hole at the bottom of the reflective cup 40 and is extended into the cavity body.

A reflective cup holder is arranged near the margin of each through hole 21 of the connector 20. The reflective cup holder of the embodiment is a circle of ribs 25 which are extended upwards along the upper surface of the connector 20; and the ribs 25 are matched with the bottom of the reflective cup 40, namely the inside diameter of the ribs 25 is equal to the outside diameter of the bottom of the reflective cup 40 and the reflective cup 40 can be fixedly arranged inside the ribs 25. Of course, if the bottom of the reflective cup 40 is in the shape of an ellipse and the like, the ribs 25 are set into corresponding shapes accordingly.

As illustrated in FIG. 4, the LED chips 30 of the beam collection combining LED illumination light source are arranged at the bottom of the reflective cups 40, namely the LED chips 30 pass through the through holes at the bottom of the reflective cups 40 and are extended into the reflective cups 40. Resins 31 are filled on the LED chips 30 and used for sealing the LED chips 30 to protect the LED chips 30.

The inner walls of the reflective cups 40 of the beam collection combining LED illumination light source can also be coated with high-reflecting films such as reflective layers made of aluminum, silver and the like, so as to highly efficiently reflect off the light.

Partial light emitted by the LED chips 30 is emitted to the inner walls of the reflective cups 40, and the incident light is reflected off by the inner walls of the reflective cups 40. As the inner walls of the reflective cups 40 are primary optical design curved surfaces which are bent inwards, the incident light emitted to the inner walls can be emitted out of the reflective cups 40 only after reflected for one time. Of course, partial light emitted by the LED chips 30 is not reflected by the inner walls of the reflective cups 40 but directly emitted to the outsides of the reflective cups 40.

As the light emitted by the LED chips 30 can be emitted out of the LED light source only after reflected for one time at best. On the assumption that the light absorption rate of the inner walls of the reflective cups 40 is 0.05, the light-emitting efficiency of the LED light source is 0.95 and is higher than that of the traditional LED light source, thus the light source waste can be avoided.

Moreover, the reflective cups 40 are revolving botube chips, namely the inner walls of the reflective cups 40 have no edges, so the phenomenon that the light emitted by the LED chips 30 can only be emitted out of the reflective cups 40 after reflected for a plurality of times is avoided, thus the light loss is greatly reduced and the light-emitting efficiency of the beam collection combining LED illumination light source is improved.

In addition, as the reflective cups 40 are designed into revolving botube chips and the height of the reflective cups 40 is far higher than that of the LED chips 30, the light emitted around by the LED chips 30 is reflected off by the inner walls of the reflective cups 40, namely the light emitted around by the LED chips 30 is reflected by the reflective cups 40 and emitted to places required to be illuminated, thus the phenomenon that the light directly irradiates human eyes and is not emitted to the surrounding of the beam collection combining LED illumination light source is avoided by considering people's habits, consequently the glare phenomenon can be avoided.

Obviously, the light emitted by the LED chips 40 is effectively controlled and emitted to the places required to be illuminated and controlled by being reflected by the reflective cups at places not required to be illuminated due to the design of the inner walls of the reflective cups 40, thus the effective control of the light is realized and the aim of avoiding glare is achieved.

When the beam collection combining LED illumination light source is designed, firstly, places required to be illuminated are mapped out according to the use environment of the beam collection combining LED illumination light source. For example, according to the driving habits of drivers, the road foundation conditions of different roads and the like if the beam collection combining LED illumination light source is used as a street lamp; secondly, the shape of the curved surfaces of the inner walls of the reflective cups 40 is designed according to the places to which the light is emitted; and thirdly, the position of the LED chips 30 is designed, so that the light emitted by the LED chips 30 can be emitted to the places required to be illuminated only after reflected for one time at best, thus the light control is realized.

Due to the inwards bent curved surfaces of the inner walls of the reflective cups 40, the light is not radially emitted to the outside after reflected by the inner walls of the reflective cups 40 but is converged to the places required to be illuminated after reflected for one time according to the reflection law, that is to say, the light-emitting angle of the beam collection combining LED illumination light source is small, thus the light-emitting efficiency of the beam collection combining LED illumination light source can be also improved.

As illustrated in FIG. 3, the connector 20 of the beam collection combining LED illumination light source is made of high temperature resistant materials such as polytetrafluoroethylene, silicon rubber and fluororubber, and is used for isolating the heat generated by the LED chips 30, so that the impact of the heat generated by the LED chips 30 on the reflective cups 40 can be avoided.

Meanwhile, as the area of the metallic conductor 11 of the copper clad layer on the upper surface of the substrate 10 is far more than that of the LED chips 30, the heat generated by the LED chips 30 is quickly spread horizontally through the metallic conductor 11 and the heat on the metallic conductor 11 is conducted to the copper clad layer on the lower surface of the substrate 10 through the ceramic materials at the center of the substrate 10 and conducted to a heat sink through the copper clad layer on the lower surface of the substrate 10.

It can be seen that the heat generated by the LED chips 30 can be quickly conducted away by adoption of the ceramic-based two-sided copper clad plate as the substrate 10, so that the high-efficiency heat dissipation of the LED light source can be realized, thus the phenomenon that the LED chips 30 are damaged due to the long-term operation in high-temperature environment can be avoided.

When the beam collection combining LED illumination light source is produced, firstly, the laying places of the reflective cups 40 and the LED chips 30 are designed according to use conditions; secondly, the metallic conductor 11 is etched on one surface of the ceramic-based two-sided copper clad plate to form the substrate 10; thirdly, the LED chips 30 are subjected to chip bonding at the corresponding position of the metallic conductor 11, and the connector 20 is fixed on the spot welding gold thread on the substrate 10; and finally, the reflective cups 40 are fixed on the connector 20 and simultaneously the resins are filled on the LED chips 30, and the beam collection combining LED illumination light source is formed after the resins are cured. Obviously, the reflective cups 40 in the beam collection combining LED illumination light source provided by the invention are subjected to one-step encapsulated molding during the production of the beam collection combining LED illumination light source.

Of course, the embodiment is only a preferred embodiment of the invention, and the beam collection combining LED illumination light source can have more changes during the actual application. For example, a connecting plate is arranged on the upper edges of a plurality of the reflective cups to connect a plurality of the reflective cups into a whole, namely a plurality of the reflective cups are subjected to integrated molding. Or the high-reflecting films and the like are not arranged on the inner walls of the reflective cups in the case of low light-emitting efficiency requirement of the beam collection combining LED illumination light source. All the changes can achieve the aims of the invention.

Finally, it shall be emphasized that the invention is not limited to the embodiment and minor changes such as the shape change of the inner walls of the reflective cups, the shape change of the through holes on the connector and the change of the materials of the connector shall be also included in the scope of protection of the Claims of the invention.

### INDUSTRIAL APPLICABILITY

As illustrated by the invention, the light emitted by the LED chips to both sides can be effectively controlled, by considering people's living habits, as the inner walls of the reflective cups are designed to be curved surfaces bended inwards and the light is reflected to places required to be illuminated due to the curved surface design of the inner walls of the reflective cups, thus effectively avoiding glare and reducing the impact of the beam collection combining LED illumination light source on drivers, pedestrians and other users.

Moreover, the reflective cups are revolving botube chips, namely the reflective cups are not provided with transitional included angles for two planes, thus the light emitted by the LED chips can be emitted from the inner walls of the reflective cups only after reflected for one time. That is to say, the LED light source adopts primary light design and the light emitted by the LED chips is only reflected for one time by the inner walls of the reflective cups, thus the light-emitting efficiency of the LED light source can be improved.

What is claimed is:

1. A beam collection combining LED illumination light source, comprising
a substrate, and one or more LED chips arranged on the substrate;
a corresponding reflective cup arranged on each LED chip, and each LED chip arranged at the bottom of the reflective cup;
the reflective cup being a revolving body, and
the inner wall of the reflective cup being a curved surface bended inwards.

2. The beam collection combining LED illumination light source according to claim 1, wherein the inner wall of the reflective cup is a conic revolving surface.

3. The beam collection combining LED illumination light source according to claim 2, wherein the conic is one part of an ellipse or a parabola.

4. The beam collection combining LED illumination light source according to any one of claims 1 to 3, wherein the inner wall of the reflective cup is coated with one layer of high-reflecting film.

5. The beam collection combining LED illumination light source according to any one of claims 1 to 3, wherein a connector is arranged on the substrate and provided with through holes, and the LED chips are arranged inside the through holes.

6. The beam collection combining LED illumination light source according to claim 5, wherein reflective cup holders are arranged on the through holes of the connector, and the reflective cups are fixed on the reflective cup holders.

7. The beam collection combining LED illumination light source according to claim 5, wherein the connector is made of high temperature resistant materials.

8. The beam collection combining LED illumination light source according to any one of claims 1 to 3, wherein the substrate is a ceramic-based two-sided copper clad plate.
